(19) United States
(12) Patent Application Publication
(10) Pub. No.: US 2017/0279684 A1
(43) Pub. Date: Sep. 28, 2017

(54) System and method for provisioning of bandwidth-on-demand (BoD) services in a telecommunications network

(71) Applicant: Tata Communications (America) Inc., Herndon, VA (US)

(72) Inventor: Ahmad Najib KHALIL, Red Bank, NJ (US)

(21) Appl. No.: 15/463,447

(22) Filed: Mar. 20, 2017

Related U.S. Application Data
(60) Provisional application No. 62/311,764, filed on Mar. 22, 2016.

(51) Int. Cl. H04L 12/24

(52) U.S. Cl. CPC H04L 41/0896

(57) ABSTRACT

A system and method for provisioning bandwidth-on-demand services in a telecommunications network. A disclosed data-processing system receives historical data for the utilization of predetermined resources, the current state of provisioned resources for a particular moment in time, and requests to provision various services to customers. The data-processing system constructs one or more mathematical functions from the historical data or the current state of provisioned resources, or both. The system provisions the service identified in the request, or provisions at least some type of service that is based on the request. The provisioning is based on one or more of the constructed mathematical functions, or on the current state of provisioned resources, or both. The system transmits a signal based on the provisioning of the service, wherein the signal can be used to route one or more data packets based on the provisioning.

### CROSS REFERENCE TO RELATED APPLICATION

The following document is incorporated by reference herein: U.S. Provisional Application Ser. No. 62/311,764, filed Mar. 22, 2016. If there are any contradictions or inconsistencies in language between this application and the document that has been incorporated by reference that might affect the interpretation of the claims in this application, the claims in this application should be interpreted to be consistent with the language in this application.

### FIELD OF THE INVENTION

The present invention relates to telecommunications in general, and, more particularly, to provisioning bandwidth-on-demand (BoD) services in a telecommunications network.

### BACKGROUND OF THE INVENTION

FIG. 1 depicts a schematic diagram of a portion of a telecommunications system in the prior art. The depicted portion includes telecommunications network 110, which comprises: layer-0 nodes 101-1 through 101-12, layer-0 route segments 102-1 through 102-17, layer-2 nodes 103-1 through 103-3, and layer-2 bundle 104-1 through 104-2. The elements within telecommunications network 110 are interrelated as shown.

Network 110 enables devices such as user endpoints to exchange data packets with one another. In particular, network 110 constitutes a wide-area network (WAN), although it could alternatively constitute a local-area network (LAN) or other type of network. Network 110 operates on Layer-2 (L-2) Provider Backbone Bridging (PBB) technology and, having one or more Ethernet rings, can be referred to as an Ethernet transport network. The connectivity among L-2 nodes, in which an L-2 connection spanning a pair of L-2 nodes is referred to as an Ethernet bundle, are routed over underlying Layer-0 (L-0) route segments, which are optical Dense Wavelength Division Multiplexing (DWDM) segments in this case. An ITU-T G.8032 ring serves as the protection mechanism at the Ethernet layer.

Layer-0 (L-0) node 101-m, wherein m can have a value equal to 1 through 12, inclusive, is a device that interconnects two or more layer-0 route segments. Each L-0 node supports DWDM.

Layer-0 (L-0) route segment 102-n, wherein n can have a value equal to 1 through 17, inclusive, refers to the physical link or medium connecting two L-0 nodes to each other. For clarity purposes, only L-0 route 102-1 is shown, although there exists an L-0 route segment 102-n between other pairs of L-0 nodes as depicted. Each L-0 route segment supports DWDM.

Layer-2 (L-2) node 103-p, wherein p can have a value equal to 1 through 3, inclusive, is a device that provides layer-2 (i.e., data link) computer networking functionality. Each L-2 node supports the Ethernet protocol. Each L-2 node comprises an L-0 node as well. As depicted, L-2 node 103-1 comprises L-0 node 101-1, L-2 node 103-2 comprises L-0 node 101-5, and L-2 node 103-3 comprises L-0 node 101-9.

Layer-2 (L-2) bundle 104-q, wherein q can have a value equal to 1 or 2, inclusive, refers to the data link that connects two L-2 nodes to each other. As depicted, L-2 bundle 104-1 connects L-2 node 103-1 and 103-2, and L-2 bundle 104-2 connects L-2 node 103-2 and 103-3. Each L-2 bundle traverses one or more L-0 route segments between the two L-2 nodes connected by L-2 bundle 104-q.

The packet-carrying capacity between pairs of nodes within telecommunications network 110 can be categorized in different ways. For example, there is a total capacity that is available for use, a provisioned capacity that is assigned to customer circuits (that is, traffic-carrying resources such as the layer-2 bundles), and an available capacity that is the difference between the total capacity and the provisioned capacity. Within each of these categories, the capacity itself can be expressed in terms of bandwidth, such as the bandwidth of or within one or more layer-2 bundles, or in terms of a different factor. In addition, the actual utilization of the customer circuits can be tracked. Service parameters other than capacity can also be specified; the latency between nodes is one such service parameter.

### SUMMARY OF THE DISCLOSURE

The invention enables the provisioning of bandwidth-on-demand (BoD) services in a telecommunications network, without at least some of the disadvantages in the prior art. A disclosed provisioning data-processing system receives historical data for the utilization of predetermined resources, the current state of provisioned resources for a particular moment in time, and requests to provision various services to customers (e.g., service providers, organizations, end users, etc.). For example and without limitation, the predetermined resources can include bandwidth of layer-2 bundles, available cards, ports, bundle latency, and/or layer-0 resources, as well as other examples of resources disclosed herein. The data-processing system constructs one or more mathematical functions from the historical data or the current state of provisioned resources, or both. The system provisions the service identified in the request, or provisions at least some type of service that is based on the request. The provisioning is based on one or more of the constructed mathematical functions, or on the current state of provisioned resources, or both. The system transmits a signal based on the provisioning of the service, wherein the signal can be used to route one or more data packets based on the provisioning.

In accordance with the illustrative embodiment, the disclosed provisioning data-processing system provisions service, to take effect at the present time or at a predetermined future time, based on the bandwidth of one or more layer-2 bundles in an Ethernet-based telecommunications network. As those who are skilled in the art will appreciate, after reading this specification, the disclosed data-processing system can provision service based on resources other than the bandwidth of one or more layer-2 bundles, or for a telecommunications networks other than one that is Ethernet-based, or both. Furthermore, the disclosed data-processing system can be used to determine the feasibility of a future provisioning of resources, instead of or in addition to the actual provisioning of those resources. Additionally, although the illustrative embodiment features the provisioning of bandwidth-on-demand services, those who are skilled in the art will appreciate, after reading this specification, that the disclosed data-processing system can provision services other than bandwidth-on-demand services.

An illustrative method comprises: receiving, by a data-processing system and at a current time: i) a request to provision, to a first customer in a plurality of customers, a first service in a telecommunications network, ii) a historical utilization for one or more layer-2 bundles in the telecommunications network, wherein the historical utilization comprises, for a plurality of past times prior to the current time (a) provisioned-bandwidth data representative of bandwidth that is provisioned for the one or more layer-2 bundles and (b) actual-utilization data representative of the actual utilization of the one or more layer-2 bundles, and iii) a current state of provisioned resources for the one or more layer-2 bundles, the current state of provisioned resources being representative of what bandwidth of which of the one or more layer-2 bundles is provisioned to which customers in the plurality of customers; determining, by the data-processing system, a provisioned-bandwidth function, G(t,x), as a function of time t and bundle x of the one or more layer-2 bundles, from the provisioned-bandwidth data for the plurality of past times; determining, by the data-processing system, an actual-utilization function, T(t,x), as a function of time t and bundle x of the one or more layer-2 bundles, from the actual-utilization data for the plurality of past times; provisioning, by the data-processing system, the first service to the first customer based on i) G(t,x), ii) T(t,x), and iii) the current state of provisioned resources; and routing one or more data packets according to the first service as provisioned.

An illustrative system comprises: a first data-processing system comprising: (b) a receiver configured to receive, at a current time: (i) a request to provision, to a first customer in a plurality of customers, a first service in a telecommunications network, (ii) a historical utilization for one or more layer-2 bundles in the telecommunications network, wherein the historical utilization comprises, for a plurality of past times prior to the current time (a) provisioned-bandwidth data representative of bandwidth that is provisioned for the one or more layer-2 bundles and (b) actual-utilization data representative of the actual utilization of the one or more layer-2 bundles, and (iii) a current state of provisioned resources for the one or more layer-2 bundles, the current state of provisioned resources being representative of what bandwidth of which of the one or more layer-2 bundles is provisioned to which customers in the plurality of customers, and (b) a processor configured to: (i) determine a provisioned-bandwidth function, G(t,x), as a function of time t and bundle x of the one or more layer-2 bundles, from the provisioned-bandwidth data for the plurality of past times, (ii) determine an actual-utilization function, T(t,x), as a function of time t and bundle x of the one or more layer-2 bundles, from the actual-utilization data for the plurality of past times, and (iii) provision the first service to the first customer based on (a) G(t,x), (b) T(t,x), and (b) the current state of provisioned resources; and a second data-processing system configured to route one or more data packets according to the first service as provisioned.

### BRIEF DESCRIPTION OF THE DRAWINGS

FIG. 1 depicts a schematic diagram of a portion of a telecommunications system in the prior art.

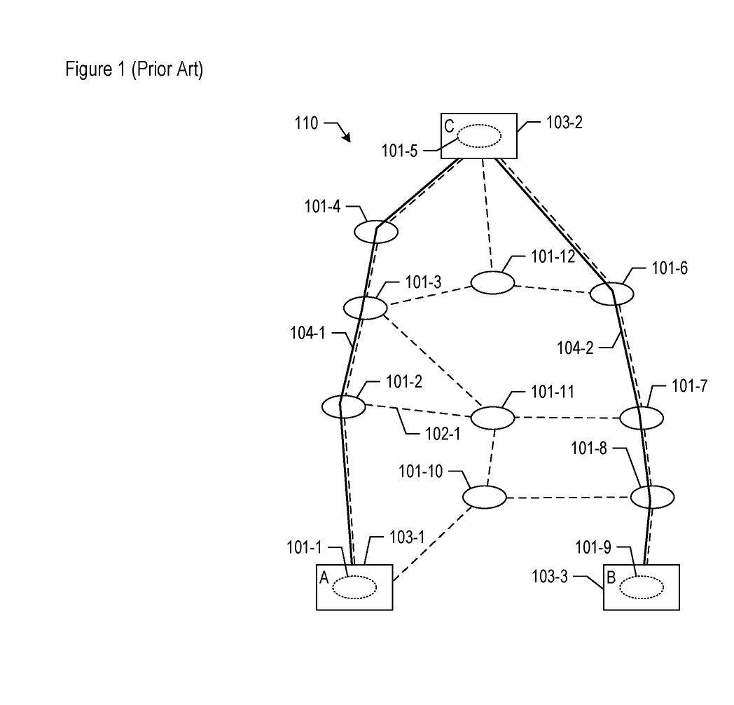

FIG. 2 depicts a schematic diagram of telecommunications system 200 in accordance with the illustrative embodiment of the present disclosure.

FIG. 3 depicts a schematic diagram of provisioning data-processing system 213, in accordance with the illustrative embodiment of the present disclosure.

FIG. 4 depicts some salient operations of method 400 according to the illustrative embodiment of the present disclosure, in which provisioning data-processing system 213 provisions service to customers in telecommunications network 210.

FIG. 5 depicts salient operations that are associated with operation 401.

FIG. 6 depicts salient operations that are associated with operation 403. In accordance with operation 601, system 213 determines a total-capacity function, F(t,x), which describes the capacity that is available on a layer-2 network for use.

FIG. 7 depicts salient operations that are associated with operation 405. In accordance with operation 701, system 213 provisions layer-2 bandwidth-on-demand (BoD) based on the available-capacity function, A(t,x).

### DETAILED DESCRIPTION

Bandwidth—For the purposes of this specification and the claims, “bandwidth” is defined as the data transfer rate, or the amount of data that can be carried from one point to another in a given time period, usually one second. Network bandwidth can be expressed in bits per second (bps).

Layer 0—For the purposes of this specification and the claims, “layer 0” is defined as the transmission medium or media in data communication network.

Layer 2—For the purposes of this specification and the claims, “layer 2” is defined as the Data Link layer of the Open Systems Interconnection (OSI) communication model.

Route segment—For the purposes of this specification and the claims, “route segment” is defined as the transmission medium path between two layer-0 nodes, with no other layer-0 nodes in between.

Network topology—For the purposes of this specification and the claims, “network topology” is defined as the arrangement of various elements (e.g., nodes, links, etc.) of a computer network or other telecommunications network. It may be depicted physically or logically.

Bundle—For the purposes of this specification and the claims, “bundle” is defined as the layer-2 connectivity between two layer-2 nodes, with no other layer-2 nodes in between.

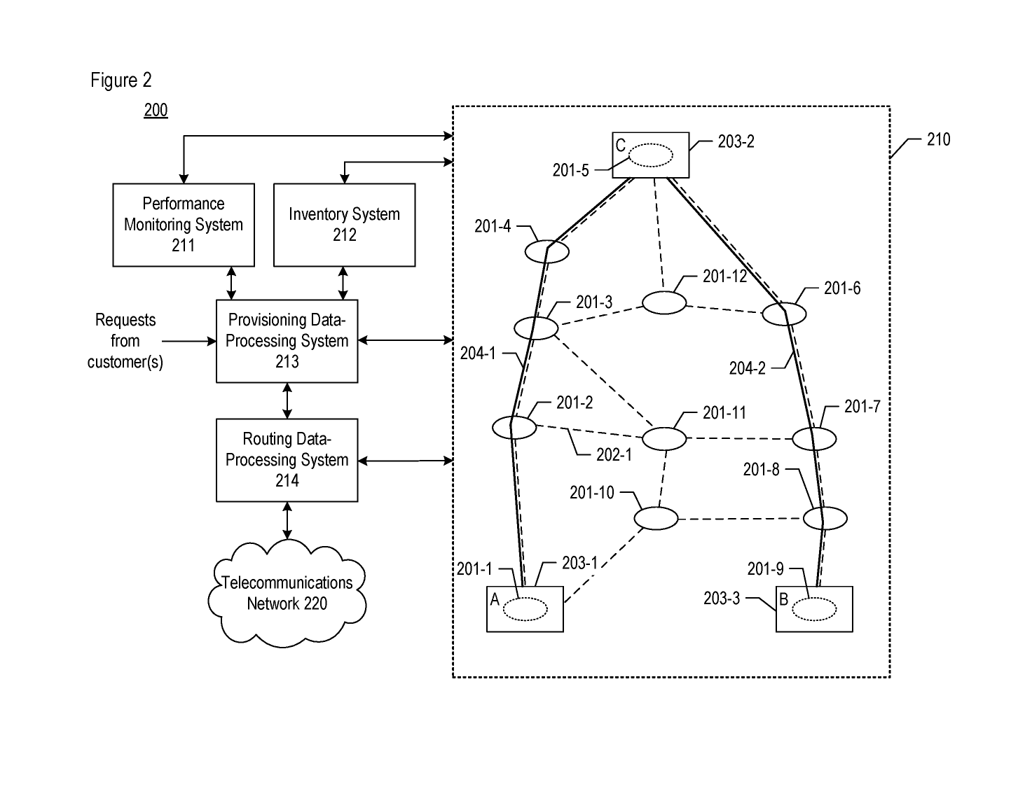

FIG. 2 depicts a schematic diagram of telecommunications system 200 in accordance with the illustrative embodiment of the present disclosure. Telecommunications system 200 comprises telecommunications networks 210 and 220, performance monitoring system 211, inventory system 212, provisioning data-processing system 213, and routing data-processing system 214, interrelated as shown.

Telecommunications network 210 comprises: layer-0 nodes 201-1 through 201-M, layer-0 route segments 202-1 through 202-N, layer-2 nodes 203-1 through 203-P, and layer-2 bundle 204-1 through 204-Q, interrelated as shown. As depicted, the integers M, N, P, and Q have values that are equal to 12, 17, 3, and 2, respectively. These integers, however, can have other values than depicted, as those who are skilled in the art will appreciate after reading this specification.

Network 210 enables devices such as user endpoints to exchange data packets with one another. In particular, network 210 constitutes a wide-area network (WAN), although in some other embodiments of the present disclosure, network 210 can constitute a local-area network (LAN) or other type of network. Network 210 operates on Layer-2 (L-2) Provider Backbone Bridging (PBB) technology and, having one or more Ethernet rings, can be referred to as an Ethernet transport network. The connectivity among L-2 nodes, in which an L-2 connection spanning a pair of L-2 nodes is referred to as an Ethernet bundle, are routed over underlying Layer-0 (L-0) route segments, which are optical Dense Wavelength Division Multiplexing (DWDM) segments in this case. An ITU-T G.8032 ring serves as the protection mechanism at the Ethernet layer.

Layer-0 (L-0) node 201-m, wherein m can have a value equal to 1 through M, inclusive, is a device that interconnects two or more layer-0 route segments. Each L-0 node supports DWDM.

Layer-0 (L-0) route segment 202-n, wherein n can have a value equal to 1 through N, inclusive, refers to the physical link or medium connecting two L-0 nodes to each other. For clarity purposes, only L-0 route 202-1 is shown, although there exists an L-0 route segment 202-n between other pairs of L-0 nodes as depicted. Each L-0 route segment supports DWDM.

Layer-2 (L-2) node 203-p, wherein p can have a value equal to 1 through P, inclusive, is a device that provides layer-2 (i.e., data link) computer networking functionality. Each L-2 node supports the Ethernet protocol and is an Ethernet point-of-presence (PoP), in some embodiments. Each L-2 node comprises an L-0 node as well. As depicted, L-2 node 203-1 comprises L-0 node 201-1, L-2 node 203-2 comprises L-0 node 201-5, and L-2 node 203-3 comprises L-0 node 201-9.

Layer-2 (L-2) bundle 204-q, wherein q can have a value equal to 1 through Q, inclusive, refers to the data link that connects two L-2 nodes to each other. As depicted, L-2 bundle 204-1 connects L-2 node 203-1 and 203-2, and L-2 bundle 204-2 connects L-2 node 203-2 and 203-3. Each L-2 bundle traverses one or more L-0 route segments between the two L-2 nodes connected by L-2 bundle 204-q. A series of multiple layer-2 nodes and bundles constitute a ring structure in network 210, such as nodes 203-1 through 203-3 with associated bundles 204-1 and 204-2.

Telecommunications network 210 is characterized as having a ring network topology. One of ordinary skill in the art will recognize, however, that the network can have a structure other than that of a single ring. Thus, in one or more other embodiments, network 210 can have a dual-ring structure, a mesh structure, a fully connected structure, or any other suitable structure. Furthermore, in other embodiments of the present disclosure, network 210 can operate on a traffic engineering technology different than PBB, can be based on a protocol different than Ethernet, can have protection switching other than ITU-T G.8032, and/or can utilize multiplexing other than DWDM.

Performance monitoring (PM) system 211 provides network performance management, comprising a set of functions that evaluate and report the effectiveness of telecommunications network 210, including one or more of the network devices that make up network 210, and the behavior of telecommunications equipment. As part of its network performance management of network 210, system 211 provides functions such as gathering statistical information, maintaining and examining historical data (e.g., logs, records, etc.), determining system performance under natural and artificial conditions, and altering system modes of operation. System 211 is capable of providing the historical data to provisioning data-processing system 213, as described below. In some embodiments of the present disclosure, the performance monitoring can be enabled via a Monolith™-based platform.

As data is broken into component parts (often known frames, packets, or segments) for transmission across telecommunications network 210, several factors can affect their delivery, including:
a) Latency: Latency refers to the delay incurred by a data packet traversing between two points in a network (e.g., between two layer-2 nodes).
   b) Packet loss: In some cases, intermediate devices in a network will lose packets. This may be due to errors, to overloading of the intermediate network, or to intentional discarding of data-packet traffic in order to enforce a particular service level.
c) Jitter: Jitter can be defined as any deviation in, or displacement of, the signal pulses in a high-frequency digital signal.
   d) Retransmission: When packets are lost in a reliable network, they are retransmitted. This incurs two delays: First, the delay from re-sending the data; and second, the delay resulting from waiting until the data is received in the correct order before forwarding it up the protocol stack.
   e) Bandwidth: Bandwidth can be defined as data transfer rate, or the amount of data that can be carried from one point to another (e.g., two layer-2 nodes) in a given time period.
      Performance monitoring system 211 is capable of collecting and providing historical data for one or more of the aforementioned factors, as exhibited various places throughout network 210 (e.g., at one or more layer-2 bundles, etc.).

Inventory system 212 provides an inventory of telecommunications network 210′s infrastructure and configuration. This includes processor-based equipment such as switches, routers, switches, and customer-premises equipment (CPE), and also cables, buildings, rooms, cabinets, and so on. Furthermore, inventory system 212 is “service aware,” in that it not only knows what equipment is installed, but also what each system, module, card, interface or cable can do, which circuits or connections are configured on the network, and which customers (e.g., service providers, enterprises, end users, etc.) and customer services use these connections and resources. System 212 is capable of providing the current state of the network, including one or more resources (e.g., bandwidth on a link, etc.) as currently provisioned (e.g., to which customers is bandwidth provisioned, how much bandwidth is provisioned, where in the network is the bandwidth provisioned, etc.), to provisioning data-processing system 213, as described below. In other words, the current state of the network can be representative of what bandwidth of which of the one or more layer-2 bundles is provisioned to which customers in the plurality of customers (e.g., 150 Mbps of bundle 1 to customer A, 200 Mbps of bundle 1 to customer B, 300 Mbps of bundle 2 to customer A, 175 Mbps of bundle 2 to customer C, etc.). In some embodiments of the present disclosure, the gathering of and reporting on inventory information can be enabled via a Cramer™-based platform, via application programming interfaces (API's).

In some embodiments of the present disclosure, provisioning data-processing system 213 can discover the current state of the network via auto discovery protocols, instead of or in addition to obtaining the inventory information from inventory system 212. For example, system 213 can use the Link Layer Discovery Protocol (LLDP), which is a vendor-neutral link layer protocol in the Internet Protocol Suite used by network devices (e.g., in telecommunications network 210, etc.) for advertising their identity, capabilities, and neighbors on an IEEE 802 local area network, principally wired Ethernet. Information gathered with LLDP is stored in the device as a management information database (MIB) and can be queried with the Simple Network Management Protocol (SNMP) as specified in RFC 2922. System 213 can discover the topology of LLDP-enabled network 210, by crawling the network devices hosting the gathered information and querying the MIB database.

Inventory information that can be retrieved can include, for example and without limitation:
a) System name and description,
b) Port name and description,
c) Virtual LAN (VLAN) name,
d) Internet Protocol (IP) management address,
e) System capabilities (switching, routing, etc.),
f) Media access control (MAC) layer/physical (PHY) layer information,
g) Media dependent interface (MDI) power (i.e., over Ethernet), and
h) Link aggregation.

Provisioning data-processing system 213 is a server computer that is configured to perform at least some of the operations discussed below. System 213 receives information related to network topology of network 210 and other relevant information, such as layer-0 topology, existing layer-2 topology, latency, and measured availability of layer-0 route segments. Based on this and other data, system 213 provisions bandwidth-on-demand (BoD) services in network 210. In some other embodiments of the present disclosure, system 213 can be based on a different computing platform than a server computer.

Provisioning data-processing system 213 can obtain the information related to network 210 from one or more sources, including performance management system 211 and inventory system 212. For example and without limitation, system 213 can receive the information via i) control paths from one or more nodes and/or links in network 210, and/or ii) data entry performed by a technician. Also, system 213 can receive requests for provisioning one or more services to one or more customers from data-processing systems operated by one or more customers that are using, or want to use, resources in network 210; alternatively, system 212 can receive such requests from third-party systems. System 213 can provide its provisioning results to routing data-processing system 214 for further processing.

System 213 comprises the capability to provision bandwidth-on-demand based on currently unused, available capacity in the network, or based on currently provisioned but unutilized capacity in the network (i.e., free capacity sitting idle in the network), or both. Capacity can be expressed in terms of bandwidth or in terms of a different factor. In some embodiments, the capability can be incorporated in a Software-Defined Network (SDN) controller. The method can be applied to point-to-point as well as multipoint Ethernet services. Also, the method can be applied to any data communications network or telecommunications network, and not only an Ethernet network. In some embodiments of the present invention, system 212 comprises the capability to predict the feasibility of future Ethernet services.

Routing data-processing system 214 is a server computer that is configured to perform routing of one or more packets through at least a portion of network 210. System 214 receives, from system 213, updated information related to network 210, including provisioning information, and provides information as appropriate to one or more nodes in network 210, which is then used to route one or more packets based on the provisioning performed by system 213. In some alternative embodiments of the present disclosure, provisioning data-processing system 213 provides the updated provisioning information directly to network 210, which is then used to route one or more packets, instead of system 214 providing the updated description.

Routing data-processing system 214, in some embodiments of the present disclosure, can also receive one or more packets originating from telecommunications network 220. Then, based on the updated provisioning information that is generated by provisioning data-processing system 213, can select a proper route through network 210 for each packet or stream of packets received from network 220.

As depicted, routing data-processing system 214 is physically distinct from provisioning data-processing system 213. However, as those who are skilled in the art will appreciate after reading this specification, the operations performed by systems 213 and 214 can be performed within the same data-processing system (e.g., server computer, etc.). Although system 214 is a server computer in some embodiments, system 214 in other embodiments can be based on different computing platform.

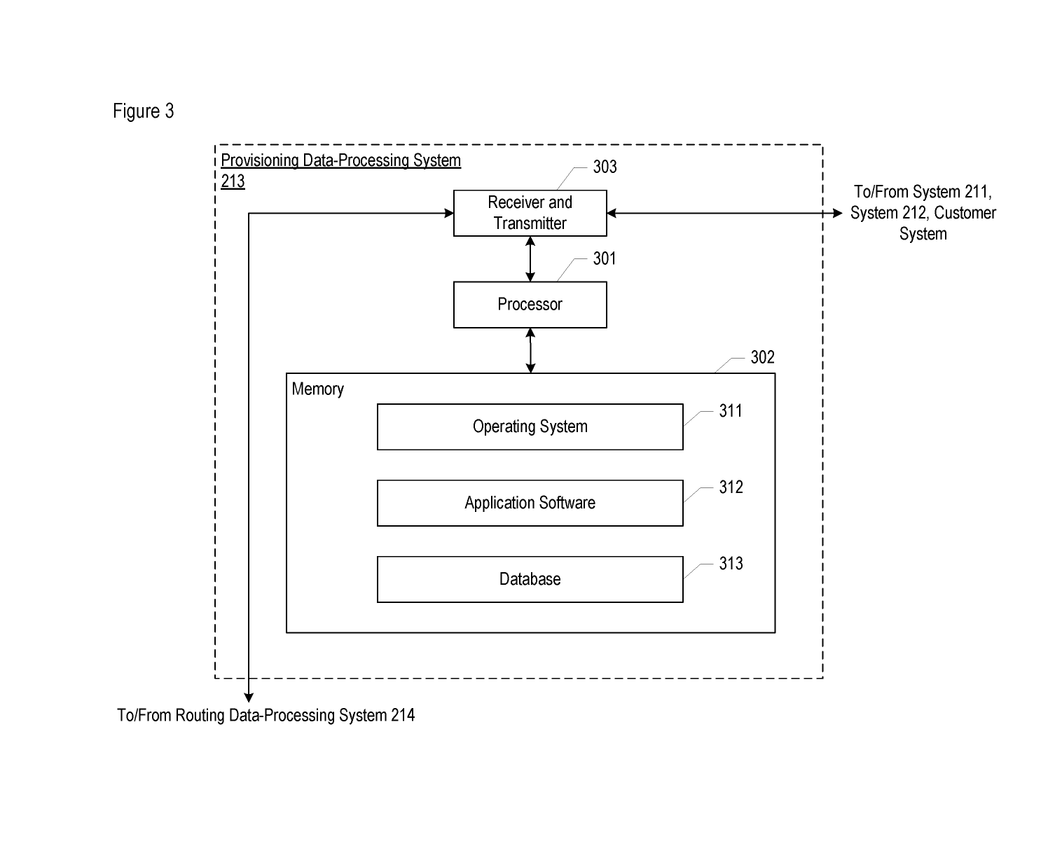

FIG. 3 depicts a schematic diagram of provisioning data-processing system 213, in accordance with the illustrative embodiment of the present disclosure. System 213 can be implemented in hardware, software, or a combination of hardware and software. Although system 213 is depicted as a single server computer, software components of the functionality disclosed herein can reside in multiple server computers, or in one or more like computing devices or machines, for that matter. The server computers or like computing devices or machines can comprise one or more central processing units (processors) and one or more memory devices. The structure and function of such server computers and the like are well known to those skilled in the art.

In accordance with the illustrative embodiment of the present disclosure, system 213 comprises: processor 301, memory 302, and receiver and transmitter 303, which are interconnected as shown. In accordance with the illustrative embodiment of the present disclosure, system 213 is a server computer. As those who are skilled in the art will appreciate after reading this specification, however, system 213 can be a different type of data-processing system.

Processor 301 is a general-purpose processor that is configured to execute an operating system and the application software that performs the operations described herein, including at least some of the operations described below. It will be clear to those skilled in the art how to make and use processor 301.

Memory 302 is non-transitory and non-volatile computer storage memory technology that is well known in the art (e.g., flash memory, etc.). Memory 302 is configured to store operating system 311, application software 312, and database 313. The operating system is a collection of software that manages, in well-known fashion, system 213's hardware resources and provides common services for computer programs, such as those that constitute the application software. The application software that is executed by processor 301 enables system 213 to perform the functions disclosed herein. Database 313 comprises information received from systems 211 and 212, and related to network topology of network 210 and other relevant information, such as layer-0 topology, layer-2 topology, latency, measured availability of layer-0 route segments, and historical utilization data. Database 313 also stores a representation of a total-capacity function (i.e., “F(t,x)”), a provisioned-capacity function (i.e., “G(t,x)”), an actual-utilization function (i.e., “T(t,x)”), an available-capacity function (i.e., “A(t,x)”), and a latency function (i.e., “S(t,x)”), which are constructed by system 213 as described below. It will be clear to those skilled in the art how to make and use memory 302.

Receiver and transmitter 303 is configured to enable system 213 to receive from and transmit to other elements within telecommunications system 200, including performance monitoring system 211, inventory system 212, routing data-processing system 214, telecommunications network 210, requesting systems, and telecommunications network 220, for example and without limitation. It will be clear to those skilled in the art how to make and use receiver and transmitter 303.

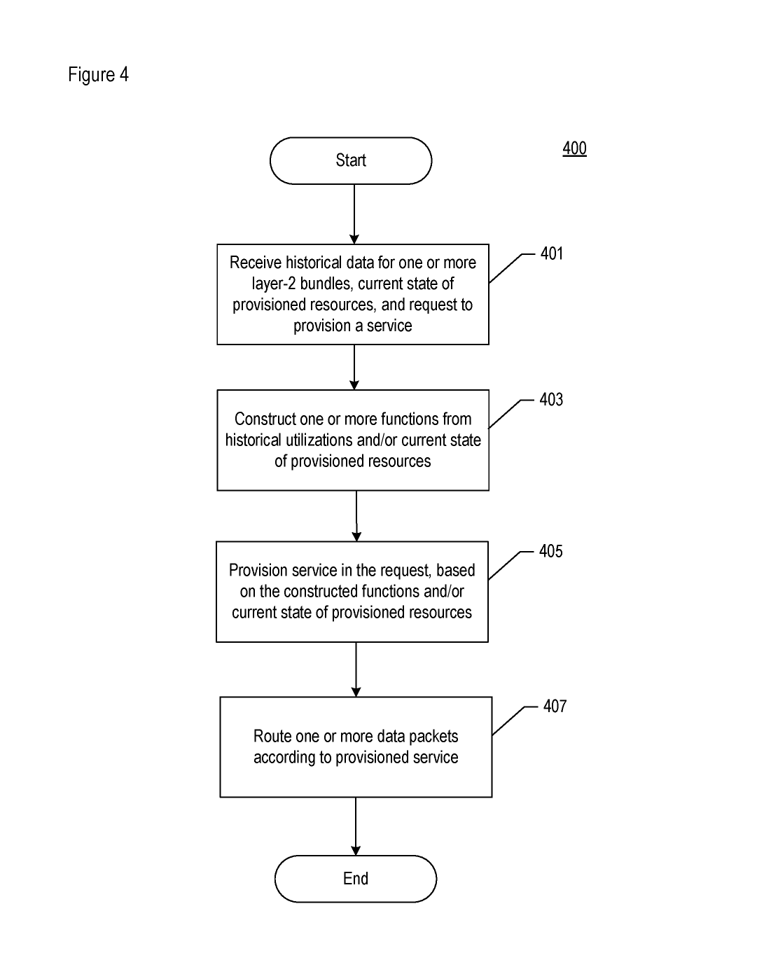

FIG. 4 depicts some salient operations of method 400 according to the illustrative embodiment of the present disclosure, in which provisioning data-processing system 213 provisions service to customers in telecommunications network 210.

In regard to method 400, as well as to the methods depicted in the other flowcharts contained herein, it will be clear to those having ordinary skill in the art, after reading the present disclosure, how to make and use alternative embodiments of the disclosed methods wherein the recited operations, sub-operations, and messages are differently sequenced, grouped, or sub-divided all within the scope of the present invention. Also, it will be further clear to those skilled in the art, after reading the present disclosure, how to make and use alternative embodiments of the disclosed methods wherein at least some of the described operations, sub-operations, and messages are optional, are omitted, or are performed by other elements and/or systems.

In accordance with the illustrative embodiment, provisioning data-processing system 213 provisions service by provisioning resources, such as bandwidth, belonging to or associated with one or more layer-2 bundles in telecommunications network 210. As those who are skilled in the art will appreciate, after reading this specification, system 213 can also provision service based on other resources such as, while not being limited to, layer-0 route segments, as well as resources for other than an Ethernet-based network such as network 210.

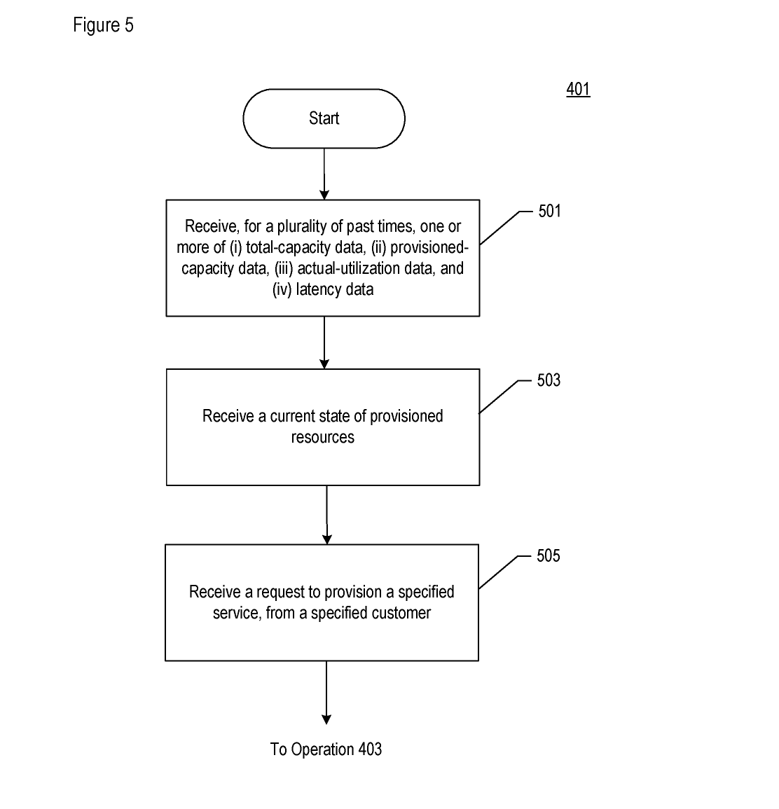

In accordance with operation 401, provisioning data-processing system 213 receives historical data for the utilization of predetermined resources (e.g., bandwidth of layer-2 bundles, etc.), the current state of provisioned resources (e.g., bandwidth of layer-2 bundles, etc.) for a particular moment in time, and requests to provision various services to customers. Operation 401 is described below and in regard to FIG. 5.

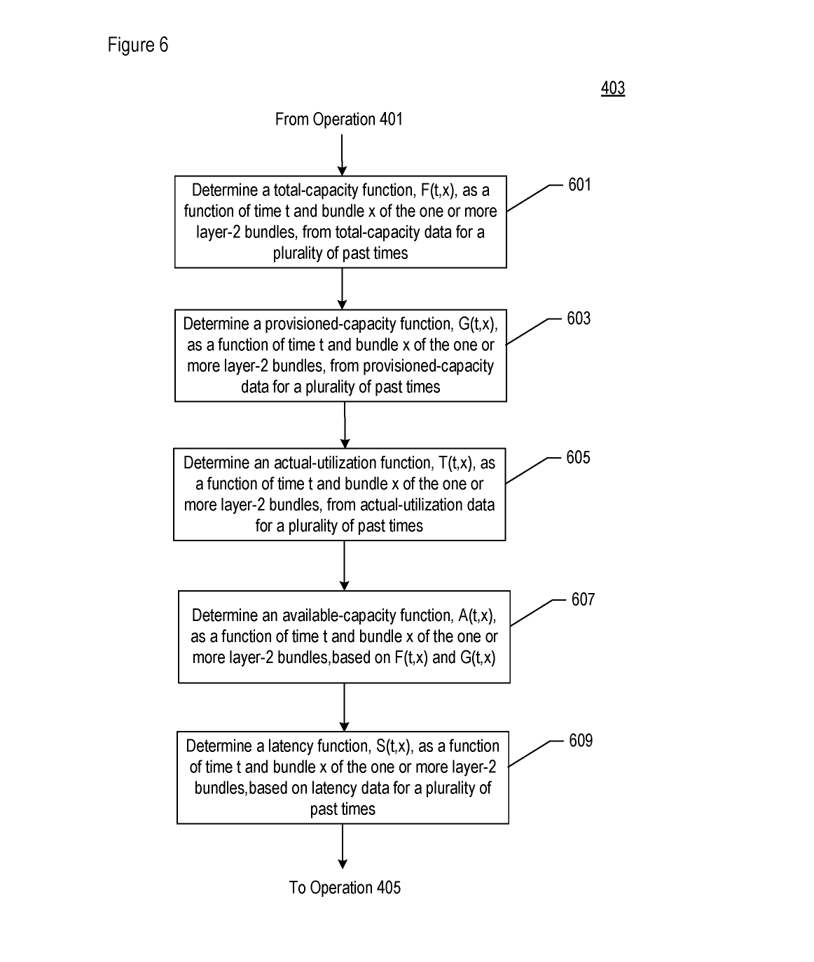

In accordance with operation 403, system 213 constructs one or more mathematical functions from the historical data or the current state of provisioned resources, or both. Operation 403 is described below and in regard to FIG. 6.

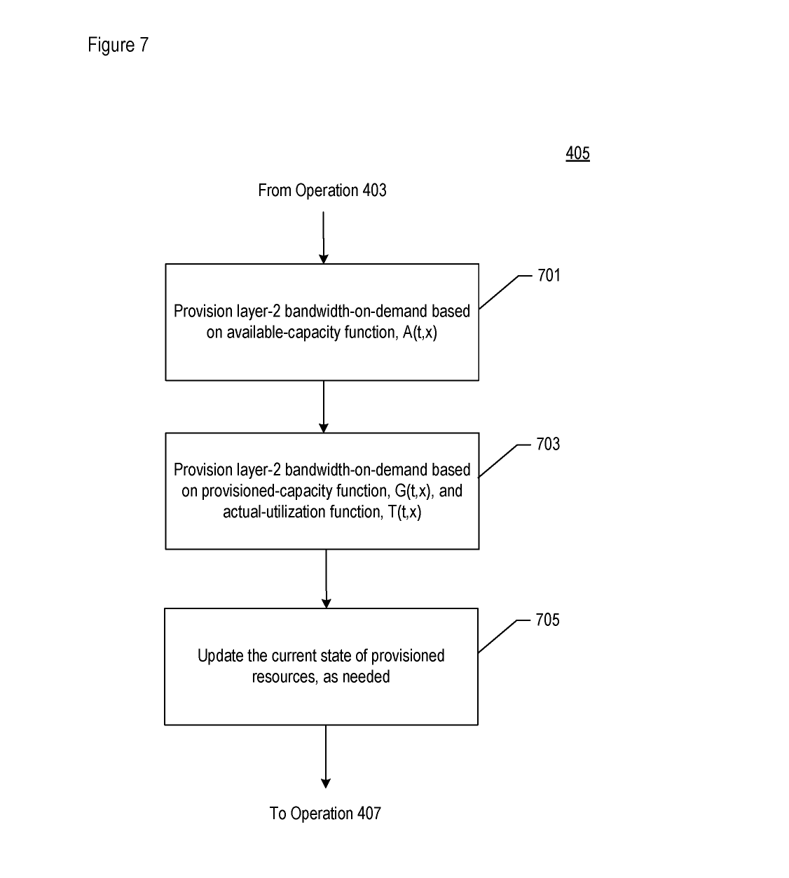

In accordance with operation 405, system 213 provisions the service identified in the request, or at least some type of service based on the request. System 213 provisions the service based on one or more of the constructed functions, or on the current state of provisioned resources, or both. Operation 405 is described below and in regard to FIG. 7.

In some embodiments of the present disclosure, and as part of a feasibility analysis described later in this disclosure, system 213 generates a prediction of what can be provisioned at a future date and time, instead of actually provisioning the service in accordance with operation 405.

In accordance with operation 407, system 213 transmits a signal to routing data-processing system 214 based on the provisioning of the service performed in accordance with operation 405. System 214 then routes one or more data packets according to the signal that it receives from system 213. System 214 routes information pertaining to a communications service (e.g., video, voice, audio, data, telephony, etc.), in accordance with the provisioning described below and in regard to FIG. 7. For example and without limitation, the information routed can be that which is transmitted between two or more parties during a telephone call.

In some embodiments of the present disclosure, it is one or more nodes within network 210 that route the one or more data packets as provisioned. These one or more nodes can be regarded as their own data-processing system. For example and without limitation, system 214 receives the signal from 213 and then provisions one or more nodes (e.g. node 203-1, 203-2, 201-3, etc.) to support the service being requested (e.g., provision layer-2 BoD according to best effort, etc.). As a result, the one or more nodes in the example then route the one or more data packets accordingly.

In some embodiments of the present disclosure, and as part of the feasibility analysis described later in this disclosure, system 213 transmits (e.g., to a display system of a user, etc.) information pertaining to a prediction of what can be provisioned at a future date and time, instead of transmitting the signal in accordance with operation 407.

FIG. 5 depicts salient operations that are associated with operation 401. In accordance with operation 501, system 213 receives historical utilization data for one or more layer-2 bundles, and/or other resources, from performance monitoring system 211. The historical utilization data comprises, for a plurality of past times, (a) total-capacity data, (b) provisioned-capacity data, and (c) actual-utilization data, and (d) latency data.

In accordance with operation 503, system 213 receives, from inventory system 212, a current state of provisioned resources of the one or more layer-2 bundles, and/or other resources, which comprises data in regard to which customer is already provisioned each of the one or more layer-2 bundles assigned, out of a plurality of customers.

In accordance with operation 505, system 213 receives a request to provision a first service for a first customer, such as “layer-2 bandwidth-on-demand,” for example and without limitation. In some embodiments, the request can come from the customer itself, while in some other embodiments, the request can originate from a third party on behalf of the customer to which the first service is to be provisioned. The first service can be based on best effort or on unused available capacity, or both, for example and without limitation.

FIG. 6 depicts salient operations that are associated with operation 403. In accordance with operation 601, system 213 determines a total-capacity function, F(t,x), which describes the capacity that is available on a layer-2 network for use. System 213 determines this as a function of time t and bundle x of the one or more layer-2 bundles, from the total-capacity data received for a plurality of past times. In accordance with the illustrative embodiment, system 213 determines this function via curve fitting at least some of the data points from the total-capacity data received; as those who are skilled in the art will appreciate, however, system 213 can use other techniques to determine F(t,x) based on the data received.

In accordance with operation 603, system 213 determines a provisioned-capacity function, G(t,x), which describes the capacity that is being assigned to customer circuits (i.e., traffic-carrying resources). System 213 determines this as a function of time t and bundle x of the one or more layer-2 bundles, from the provisioned-capacity data received for a plurality of past times. In accordance with the illustrative embodiment, system 213 determines this function via curve fitting at least some of the data points from the provisioned-capacity data received; as those who are skilled in the art will appreciate, however, system 213 can use other techniques to determine G(t,x) based on the data received.

In accordance with operation 605, system 213 determines an actual-utilization function, T(t,x), which describes the actual utilization of capacity by customer circuits. System 213 determines this as a function of time t and bundle x of the one or more layer-2 bundles, from the actual-utilization data received for a plurality of past times. In accordance with the illustrative embodiment, system 213 determines this function via curve fitting at least some of the data points from the actual-utilization data received; as those who are skilled in the art will appreciate, however, system 213 can use other techniques to determine T(t,x) based on the data received.

In accordance with operation 607, system 213 determines an available-capacity function, A(t,x), as a function of time t and bundle x of the one or more layer-2 bundles, based on F(t,x) and G(t,x). In some embodiments of the present disclosure, this function is equal to the difference between F(t,x) and G(t,x).

In accordance with operation 609, system 213 determines a latency function, S(t,x), as a function of time t and bundle x of the one or more layer-2 bundles, based on the latency data received for a plurality of past times. In accordance with the illustrative embodiment, system 213 determines this function via curve fitting at least some of the data points from the latency data received; as those who are skilled in the art will appreciate, however, system 213 can use other techniques to determine S(t,x) based on the data received.

Similarly, system 213 can determine a function for one or more of the other factors affecting performance (i.e., other than latency) and collected by performance monitoring system 211, and can provision services to customers in consideration of such a function.

FIG. 7 depicts salient operations that are associated with operation 405. In accordance with operation 701, system 213 provisions layer-2 bandwidth-on-demand (BoD) based on the available-capacity function, A(t,x). In some alternative embodiments of the present disclosure, system 213 provisions a different resource than layer-2 bandwidth. For a given request for a specific bandwidth from point A to point Z (as in a point-point request), various path computation constraint-based routing algorithms can be considered. Such routing algorithms can include, for example and without limitation: least utilized bundles, which also considers T(t,x) in addition to A(t,x); most utilized bundles, which also considers T(t,x); lowest latency routing, which also considers S(t,x); and so on. A decision can be made whether this requested bandwidth can be successfully provisioned right now or not. This BoD request can be processed by considering available capacity, A(t,x), which requires reservation and update to inventory system 212.

In accordance with operation 703, system 213 provisions layer-2 bandwidth-on-demand based on the provisioned-capacity function, G(t,x), and the actual-utilization function, T(t,x). This relates to another type of service that can be provided by system 213, best-effort (BE) service. This is a method to assign sold, but unutilized, capacity to additional customers. In some alternative embodiments of the present disclosure, system 213 provisions a different resource than layer-2 bandwidth.

For this type of service, the idea is to utilize capacity that was previously sold to a first set of one or more customers, but is sitting idle (i.e., the customer is not sending enough traffic on the provisioned circuit), and use it to provide BE services to a second set of one or more customers. For this type of service, inventory system 212 does not need to be updated.

The following is an example to show what historical data can be obtained from performance monitoring (PM) system 211 and inventory system 212, in order to support this service scenario. For a given Ethernet bundle x in network 210 (e.g., actual link between Los Angeles and Santa Clara) system 213 can obtain the historical utilization data in Table 1 below, from PM system 211 and in accordance with operation 501.

TABLE 1

| | Total | Provisioned | Available | Actual |
|---|---|---|---|---|
| Time | BW | BW | BW | Utilization |
| Period | (Mbps) | (Mbps) | (Mbps) | (Mbps) |
| May 2013 | 8528 | 4309 | 4,219 | 809.86 |
| July 2013 | 25584 | 4477 | 21,107 | 725.77 |
| September 2013 | 25584 | 4057 | 21,527 | 1094.41 |
| November 2013 | 25584 | 4107 | 21,477 | 1066.59 |
| January 2014 | 25584 | 4675 | 20,909 | 488.40 |
| April 2014 | 25584 | 4155 | 21,429 | 923.95 |
| July 2014 | 25584 | 4657 | 20,927 | 1069.40 |
| October 2014 | 25584 | 4907 | 20,677 | 1010.37 |
| January 2015 | 25584 | 7652 | 17,932 | 1561.87 |
| April 2015 | 25584 | 9974 | 15,610 | 757.49 |
| July 2015 | 25584 | 16806 | 8,778 | 348.11 |
| October 2015 | 25584 | 20892 | 4,692 | 191.80 |
| January 2016 | 34112 | 24524 | 9,588 | 1098.32 |

As can be seen in the table, the actual utilized capacity (i.e., actual utilization) is much lower than the provisioned bandwidth (BW). An average utilization for this link can be calculated from the actual utilization data; accordingly, system 213 can estimate the amount of bandwidth that is being provisioned and not utilized at the current time in the link. In some embodiments, a different threshold scheme can be used; for instance, instead of the average utilization, the maximum utilized bandwidth can be used (e.g., 1098.32 Mbps in January 2016). This estimating of bandwidth can be done for every link in network 210.

With a virtualized graph of the network with such information, system 213 can use the capacity to provision best-effort Ethernet services (i.e., various routing algorithms can be applied with weight function that is related to the capacity utilization and/or latency). In case the actual utilization of the provisioned services increases and reaches the (actual) provisioned bandwidth, the best effort traffic can be dropped (e.g., class-of-services can be used to achieve this). In the example below, the average of the actual utilization data points for this specific link is 880 Mbps. The provisioned bandwidth at January 2016 (i.e., the current time in this example) is 24,524 Mbps. Based on the difference between 24,524 and 880 Mbps, a value that is equal to 23,644 Mbps of best-effort traffic can be provisioned on this bundle. This can be performed on every bundle along the desired path that is calculated, or on a proper subset of the bundles along the desired path, or on a different set of bundles.

In some embodiments of the present disclosure, different schemes can be used, including one in which system 213 applies an oversubscription factor to always ensure that the entire unutilized capacity is not being provisioned for best effort traffic. For instance, only 50% of the provisioned but unutilized capacity can be allocated to best-effort traffic, and for this bundle the value is (23,644)*(0.50)=11,822 Mbps.

Returning now to FIG. 7, in some embodiments of the present disclosure as part of operation 703, system 213 provisions the first service to the first customer, further based on the current state of provisioned resources. In this regard, the provisioning can be based on a relationship of the first customer to at least one other customer in the plurality of customers. This relationship is reflected in the current state of provisioned resources, which is representative of what bandwidth of which of the one or more layer-2 bundles is provisioned to which customers in the plurality of customers. In terms of considering customer relationships to one another, system 213 might provision in a first way because two customers are competitors, while system 213 might provision in a second way because two customers are in a strategic partnership. In some embodiments of the present disclosure, the current state of provisioned resources merely represents historical utilization data being created for the present date and time, while in other embodiments of the present disclosure, the current state of provisioned resources is not considered to be representative of any historical utilization, either past or present.

In some embodiments of the present disclosure, system 213 provisions the first service in accordance with both operations 701 and 703. For example, system 213 might attempt to provision some or all of the resources being requested for a customer based on the available-capacity function (A(t,x)) in accordance with operation 701. Then, system 213 can go on to provision at least some of the resources (e.g., within the same bundle, within a different bundle from that which was considered via operation 701, etc.) being requested for the customer, based on provisioned-capacity (G(t,x)) and actual-utilization (T(t,x)) in accordance with operation 703. In this example, system 213 might provision based on operation 703 once system 213 determines that all available capacity is exhausted (e.g., for a given bundle, etc.).

In regard to processing a request to provision a service, an alternative option is to process a request by provisioning a longer or different route than specified in the request between the same endpoints, but with the same capacity as in the request. Yet a different alternative is to provision less capacity, but with the same latency. And still a different alternative is to provision the requested capacity, albeit with more latency. This can be applied to both service scenarios discussed above (i.e., the first and second service scenarios in accordance with operations 701 and 703, respectively).

In accordance with operation 705, system 213 updates the current state of provisioned bandwidth, as needed. For example, system 213 updates inventory system 212 with the details about the provisioned bandwidth or other factor, as a result of operation 701.

In some embodiments of the present disclosure, from the information obtained from performance monitoring system 211 and inventory system 212, system 213 can predict the probability of successful provisioning of the requested bandwidth on demand. For example, this can be achieved either via a developed mathematical model or an empirical model using the historical data.

A statistical model can be utilized by system 213 to calculate the probability distribution for the requested BW. This can be performed with integer-linear programing/mathematical modelling, as well by building an empirical probability distribution based on the historical data. For instance, system 213 can calculate the probability for a link in the network to have a certain available minimum bandwidth using the total number of historical data points that satisfies the requirement, divided by the total sample historical data points. This can be applied to unused bandwidth (i.e., the first service scenario, discussed above and in accordance with operation 701) as well as to used but unutilized bandwidth (i.e., the second service scenario, discussed above and in accordance with operation 703).

Using the statistical model, a virtual image of network 210 can be created anytime in the future, so a feasibility analysis for any given request can be made with a time of successful provisioning. In other words, if the requested bandwidth cannot be accommodated at the current time, or if the customer is interested in provisioning at a predetermined future date and time, system 213 can extrapolate A(t, x), F(t, x), G(t, x), and T(t, x) to time t_{future} that is in the future. This enables predicting the state of the capacity on network bundles in the future to a certain confidence level, using statistical analysis to calculate the probability distribution for having a certain bandwidth threshold on various layer-2 bundles. Using such information, the probability to provide both services described above and in regard to operations 701 and 703 can be obtained and returned as part of a feasibility analysis or as an actual provisioning of resources to take effect at a future date and time.

Another way to understand this is that system 213 is capable of building a mathematical model. To do so, system 213 uses the historical data, rather than a mere projection. Processing logic is used to keep changing or adapting the model (e.g., changing the type of curve fitting, etc.) based on the circumstances. Such circumstances can include, for example, the amount of bandwidth the customer wants, the latency the customer is willing to tolerate, the variance, and the time in the future, t_{future}, for which a model is sought.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving, by a data-processing system and at a current time:
i) a request to provision, to a first customer in a plurality of customers, a first service in a telecommunications network, i
i) a historical utilization for one or more layer-2 bundles in the telecommunications network, wherein the historical utilization comprises, for a plurality of past times prior to the current time (a) provisioned-bandwidth data representative of bandwidth that is provisioned for the one or more layer-2 bundles and (b) actual-utilization data representative of the actual utilization of the one or more layer-2 bundles, and
iii) a current state of provisioned resources for the one or more layer-2 bundles, the current state of provisioned resources being representative of what bandwidth of which of the one or more layer-2 bundles is provisioned to which customers in the plurality of customers;
determining, by the data-processing system, a provisioned-bandwidth function, G(t,x), as a function of time t and bundle x of the one or more layer-2 bundles, from the provisioned-bandwidth data for the plurality of past times;
determining, by the data-processing system, an actual-utilization function, T(t,x), as a function of time t and bundle x of the one or more layer-2 bundles, from the actual-utilization data for the plurality of past times;
provisioning, by the data-processing system, the first service to the first customer based on i) G(t,x), ii) T(t,x), and iii) the current state of provisioned resources; and
routing one or more data packets according to the first service as provisioned.

2. The method of claim 1 wherein the provisioning is based on a difference between i) G(t,x) and ii) a function that is based on T(t,x).

3. The method of claim 2 wherein the function that is based on T(t,x) is an average utilized bandwidth over a given period of time for bundle x.

4. The method of claim 2 wherein the function that is based on T(t,x) is a maximum utilized bandwidth over a given period of time for bundle x.

5. The method of claim 1 wherein the provisioning is further based on a relationship of the first customer to at least one other customer in the plurality of customers.

6. The method of claim 1 wherein the provisioning is based on multiple layer-2 bundles having been assessed.

7. The method of claim 1 wherein the provisioning is further based on the current state of provisioned resources of the one or more layer-2 bundles.

8. The method of claim 1 wherein the provisioned service is best effort.

9. The method of claim 1 further comprising determining a latency, S(t,x), as a function of time t and bundle x of the one or more layer-2 bundles, wherein the latency is based on the historical utilization, and wherein the provisioning is further based on S(t,x).

10. The method of claim 1 wherein the provisioning is further based on an oversubscription factor.

11. A telecommunications system comprising:
a first data-processing system comprising:
(b) a receiver configured to receive, at a current time:
(i) a request to provision, to a first customer in a plurality of customers, a first service in a telecommunications network,
(ii) a historical utilization for one or more layer-2 bundles in the telecommunications network, wherein the historical utilization comprises, for a plurality of past times prior to the current time (a) provisioned-bandwidth data representative of bandwidth that is provisioned for the one or more layer-2 bundles and (b) actual-utilization data representative of the actual utilization of the one or more layer-2 bundles, and
(iii) a current state of provisioned resources for the one or more layer-2 bundles, the current state of provisioned resources being representative of what bandwidth of which of the one or more layer-2 bundles is provisioned to which customers in the plurality of customers, and
(b) a processor configured to:
(i) determine a provisioned-bandwidth function, G(t,x), as a function of time t and bundle x of the one or more layer-2 bundles, from the provisioned-bandwidth data for the plurality of past times,
(ii) determine an actual-utilization function, T(t,x), as a function of time t and bundle x of the one or more layer-2 bundles, from the actual-utilization data for the plurality of past times, and
(iii) provision the first service to the first customer based on (a) G(t,x), (b) T(t,x), and (b) the current state of provisioned resources; and
a second data-processing system configured to route one or more data packets according to the first service as provisioned.

12. The system of claim 11 wherein the processor is configured to provision further based on a difference between (a) G(t,x) and (b) a function that is based on T(t,x).

13. The system of claim 12 wherein the function that is based on T(t,x) is an average utilized bandwidth over a given period of time for bundle x.

14. The system of claim 12 wherein the function that is based on T(t,x) is a maximum utilized bandwidth over a given period of time for bundle x.

15. The system of claim 11 wherein the processor is configured to provision further based on a relationship of the first customer to at least one other customer in the plurality of customers.

16. The system of claim 11 wherein the processor is configured to provision based on multiple layer-2 bundles having been assessed.

17. The system of claim 11 wherein the processor is configured to provision further based on the current state of provisioned resources of the one or more layer-2 bundles.

18. The system of claim 11 wherein the provisioned service is best effort.

19. The system of claim 11 wherein the processor is further configured to determine a latency, S(t,x), as a function of time t and bundle x of the one or more layer-2 bundles, wherein the latency is based on the historical utilization, and wherein the processor is configured to provision further based on S(t,x).

20. The system of claim 11 wherein the processor is configured to provision further based on an oversubscription factor.
